(19) United States
(12) Patent Application Publication
(10) Pub. No.: US 2014/0260694 A1
(43) Pub. Date: Sep. 18, 2014

(54) Automated Tracer Sampling and Measurement System

(71) Applicant: Stefan Michael Szlendak, San Ramon, CA (US)

(72) Inventor: Stefan Michael Szlendak, San Ramon, CA (US)

(73) Assignee: Chevron U.S.A. Inc., San Ramon, CA (US)

(21) Appl. No.: 13/835,466

(22) Filed: Mar. 15, 2013

(51) Int. Cl. G01N 1/20

(52) U.S. Cl. CPC G01N 1/20
USPC 73/863.51

(57) ABSTRACT

Methods and systems for automatically sampling and measuring tracers in a reservoir are disclosed. One system includes an inline system containing a filtering system, a phase separation device, and a measurement device, wherein the system is connected to a data communication network for displaying results regarding the concentration of at least one tracer in the measured sample.

### TECHNICAL FIELD

The present disclosure relates generally to testing for and measuring the concentration of a tracer in a fluid sample. More particularly, the present disclosure is directed to automated sampling and measurement of a fluid for at least one tracer.

### BACKGROUND

Tracers are frequently used in oil, water, and gas industries to track flow patterns and rates of the particular fluid to which it is introduced. Tracers are also used to study properties of the reservoir or aquifer in which the fluid resides. Tracers commonly are chemical compounds that have negligible effects on the producing fluid. In operation, tracers are injected into a reservoir or aquifer, and thereafter produced and sampled to measure for tracer concentration.

The present practice of sampling and measuring the concentration of a tracer produced from a reservoir or aquifer is rudimentary and involves a field operator manually collecting a sample, transporting the sample to a laboratory, filtering the sample, and finally measuring the sample for tracer concentration. In other embodiments, an automatic sampler is used to automatically extract a sample and seal it into a vial. However, an operator is still required to transport the vials to a laboratory facility where it is thereafter filtered and measured.

Sample contamination, operator burden, significant cost, and delay are frequently encountered problems with the current method for sampling and measurement of a tracer in a reservoir. Furthermore, failed tracer testing is due largely in part to problems created by poor sampling.

### SUMMARY

In general terms, this disclosure is directed to an automated tracer sampling and measurement system. In one possible configuration and by non-limiting example, the automated tracer sampling and measurement system is used for detecting one or more tracers introduced in a reservoir for evaluation purposes.

One aspect of the present disclosure is an automated tracer sampling and measurement system comprising a flange wellhead slipstream device connected to a producing well (e.g., a wellhead or production manifold) and a housing for an inline system used for tracer sampling and measurement, wherein the housing is further connected to the flange wellhead slipstream device. The inline system further comprises a phase separation system, a tracer measurement device configured for detecting a concentration of an at least one tracer produced from a reservoir, and a fluid flow system comprising of at least one of pipes, pumps, and valves.

Another aspect of the present disclosure is a method for sampling and measuring tracers, the method comprising automatically extracting, from produced fluid of a reservoir, a sample set of fluid, having at least two phases and at least one tracer, using a slipstream device, automatically separating the at least two phases into a first phase and a second phase using a phase separation system and automatically reintroducing the second phase into the produced fluid of the reservoir using the slipstream device. The method further comprises automatically measuring a concentration of the at least one tracer in the first phase using a tracer measurement device, and automatically reintroducing the first phase into the produced fluid of the reservoir using the slipstream device.

Another aspect of the present disclosure is an automated tracer sampling and measurement device comprising a flange wellhead slipstream device and a housing for an inline system used for tracer sampling and measurement, wherein the housing is connected to the flange wellhead slipstream device. The inline system further comprises a phase separation system connected to a tracer measurement device configured for detecting a concentration of at least one tracer, and a fluid transport system comprising of a series of piping and valves.

### BRIEF DESCRIPTION OF THE DRAWINGS

FIG. 1 is a schematic block diagram of a system using an automated tracer sampling and measurement system.

FIG. 2 is a flow chart of a non-integrated method for performing tracer measurement.

FIG. 3 is a flow chart of a method used by an automated tracer sampling and measurement system.

FIG. 4 is a block diagram of an automated tracer sampling and measurement system for detecting a flow pattern of a tracer in a reservoir.

FIG. 5 is a flow chart of a system using an automated tracer sampling and measurement system.

FIG. 6 is a flow chart of an example method used by an automated tracer sampling and measurement system using a hydrocyclone phase separation device.

FIG. 7 is a flow chart of an example method used by an automated tracer sampling and measurement system using a vertical column gravity segregation system.

FIG. 8 is a flow chart of a tracer measurement device used by an automated tracer sampling and measurement system.

FIG. 9 is a chart illustrating example combinations of alternative embodiments for the automated tracer sampling and measurement system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure describes an integrated approach to sampling, processing, and measuring tracers in a reservoir or aquifer which automates one or more steps in the process. The systems and methods, according to the present disclosure, solve at least some of the aforementioned problems of sample contamination, operator burden, cost, and delay associated with the current system frequently caused by manual tasks. In some embodiments of the present disclosure, an automated solution is installed as an integrated inline system at or near a wellhead or production manifold. The integrated inline system can be incorporated in existing onshore or offshore wellhead configurations. This embodiment also works reliably and durably in harsh oilfield environments. Because of task automation, the cost of the system is equal to or less than the cost of the current practice of tracer sampling. The terms “automatic” and “automated” denote functions and processes that can be conducted using tools and mechanisms, directed by a computing device, that do not physically require human effort to accomplish. For example, in existing systems, a field operator extracts samples from a wellhead. The automated approach discussed herein allows an extraction device to collect samples at pre-established intervals, thereby eliminating the need for the field operator to manually extract the sample from the wellhead. In addition, one or more steps or processes can be automated, allowing for simpler (and less time-intensive) tracer measurement.

Types of tracers that are introduced into the reservoir or aquifer that can be used with the system according to the present disclosure include, but are not limited to fluorinated benzoic acids (FBAs), fluorescein dyes, a FBA/fluorescein synthesis, fluorescing nanocrystals, radioactive tracers, fluorescing nanoparticles, and a LUX Assure Tracer™. FBAs demonstrate low detection points whereas radioactive tracers can be measured without the need to separate phases in a sample. Magnetic nanoparticle tracers have detection thresholds as low as 1 part per billion (ppb) and can be used to distinguish other produced solids. In some embodiments, the type of tracer injected in the reservoir has a low rate of absorption upon the formation rock.

FIG. 1 is a schematic block diagram illustrative of a system 100 using an automated tracer sampling and measurement system 102. In this example embodiment, the system 100 includes an automated tracer sampling and measurement system (hereinafter automated system) 102 located near a wellhead 104. Alternatively, the automated system 102 can be placed near a production manifold. In this embodiment, the wellhead 104 and automated system 102 are located on a ground surface 110 onshore, above the reservoir 112. In other embodiments, the wellhead 104 and automated system 102 are located on an offshore surface such as above a deep water drilling site. In this embodiment, the automated system 102 is a skid system packaged into a single unit. The automated system 102 is in wireless communication with one or several computing devices 108 via the data communication network 106. In some embodiments, the automated system 102 is powered by a local power source such as a variety of solar panels connected thereto. In other embodiments, electrical components of the automated system 102 are powered using one or more batteries, generators, or other types of power supplies. The automated system 102 is described in more detail with reference to FIGS. 3-5.

In this embodiment, the wellhead 104 provides a structural interface for extracting fluids from the reservoir 112. Example fluids that flow in a reservoir are oil, water, gas, or a combination thereof. The automated system 102 is located near and connected to the wellhead 104. In some embodiments, the automated system 102 is connected to the wellhead 104 using a series of pipes appropriate for extracting fluid samples from the wellhead 104. In other embodiments, other connection interfaces are used.

In this embodiment, the computing devices 108 can be used to automate the one or more processes of the present disclosure. The computing devices 108 can also be used to display measurement results and/or a status of the automated system 102. Additionally, a single computing device 108 can be linked to one or more automated systems 102. The computing devices 108 can be any one of a variety of computing devices including, but not limited to a desktop computing device, a mobile computing device (such as a laptop, smartphone, tablet computer, and the like), or it can be another type of computing device.

Similarly, the automated system 102 provides data to, and receives data from, one or more computing devices 108 over the data communication network 106. The data communication network 106 can be any variety of communication networks including, but not limited to a wide area network such as the Internet, a local area network, or any other Internet based network.

FIG. 2 is a flow chart illustrating a non-integrated method 200 of performing tracer measurement. The method 200 includes installation of a system (step 202), introduction of a tracer (step 204), collection of at least one sample (step 206), transportation of the sample(s) to an externally located laboratory (step 208), filtration of the sample(s) in the laboratory (step 210), measurement of the sample(s) for tracers (step 212) in the laboratory, and display of results (step 214).

In this embodiment, the install system (step 202) involves an initial installation of valves at a wellhead or production manifold. The valves allow a field operator to access fluid from the wellhead to extract samples therefrom. Following system install (step 202) and the introduction of a tracer (step 204) into the reservoir, an operator collects at least one sample (step 206) of the oil, gas, and/or water from the wellhead or production manifold. In some embodiments, the operator siphons off a sample containing gas, oil, water, tracer, and solids. Alternatively, an automatic sampler device is used to collect at least one sample (step 206) of the tracer, oil, gas, or water mixture. Following collection of at least one sample (step 206), the operator transports the sample(s) to a laboratory (step 208) that is located remote from the wellhead location. In the laboratory, a technician removes solids from and separates the sample into various phases (step 210). The laboratory technician then measures one of the separated phases in the laboratory (step 212) for tracer concentration using a tracer measurement device. In some embodiments, the tracer measurement device used in the laboratory is a high performance liquid chromatography device. In other embodiments, a laboratory operator evaluates the sample by first removing solids and sediments and separating phases (step 210), if necessary, and measures the concentration of the tracer in the sample (step 212) using a spectroscope measurement device capable of detecting fluorescence tracers. In other embodiments, other measurement devices are used. The measurement device then displays the results (step 214) of the concentration of tracers found in the sample. Because each step of the sampling and measurement process requires the use of an operator and/or a laboratory technician, this embodiment is not a fully automated approach.

FIG. 3 is a flow chart of a method 300 used by an automated tracer sampling and measurement system 102 as shown and described with respect to FIG. 1. This example embodiment describes a method 300, used by a computing device, for performing tracer measurement in an automated and integrated embodiment. The method 300 includes installing the system (step 302), extracting at least one sample (step 304), filtering the sample (step 306), separating the sample into phases (step 308), measuring the sample (step 310), and displaying results (step 312).

In this embodiment, system install (step 302) involves the initial installation of the automated system 102 at or near the wellhead or production manifold. As discussed above, the automated system 102 is a skid system that is packaged as a single unit and capable of being easily installed into the current wellhead design. In some embodiments, the automated system 102 can be uninstalled, relocated, and re-installed, using a flatbed truck or other means of transport, into other wellhead or production manifold structures. Once the system is physically in place, installing the system (step 302) further involves extracting a sample of fluid to ensure that the automated system 102 captures a sample containing more than 10% water so that the measurement device can accurately detect the presence and concentration of a tracer. Installing the system (step 302) further involves installing a transport system for transferring collected samples to a measurement device. These transport systems include a series of pipes and valves that facilitate the movement of the sample from one device to another.

The method 300 further includes automatically extracting at least one fluid sample (step 304) from a wellhead via an installed flange wellhead slipstream device (slipstream). The automatic extraction of the sample (step 304) can include using an automatic sampler device as described above. In other embodiments, the automatic extraction of the sample (step 304) includes using a device that automatically extracts samples of fluid using the slipstream device. The slipstream device is placed between the wellhead and the automated system 102 and is used to extract samples from the wellhead and reintroduce measured samples back into the produced fluid from the well such as at the wellhead or production manifold. In some embodiments, a computing device is used to establish how often extraction of a sample (step 304) must occur and/or the amount necessary for extraction. In some embodiments, extraction of a sample can be established, by a computing device, to occur at any time between every 4 hours-24 hours. In other embodiments, automatic extraction can occur at intervals outside this range.

Once a sample is extracted (step 304), the sample is sent to a filtration system using pumps that flow the sample through the automated system 102. The sample is filtered (step 306) to remove solids, salts, and other formations from the extracted sample.

Once the solids and other formations are removed (step 304), the sample is automatically pumped to a phase separation device where the sample is separated into an aqueous phase and an output phase (step 308). The phase separation device is described in more detail with respect to FIGS. 4-7. The output phase is then pumped back to the slipstream device to be reintroduced into the produced fluid from the well such as at the wellhead.

After phase separation (step 308), the sample is automatically sent to the measurement device using a pump. The measurement device then measures the sample(s) (step 310) for tracers. In this embodiment, the measurement device used is a fluorometer or a fiber optic fluoro-spectroscope. In other embodiments, other types of measurement devices are used. In some embodiments, the measurement device is connected to a data communication network 106 (FIG. 1).

In some embodiments, once measuring at least one sample (step 310) is completed, the measurement device automatically sends tracer concentration results, over the data communication network 106 (FIG. 1), to a computing device 108 (FIG. 1) that displays the results (step 312). In some embodiments, the results are stored on a database computing device. In some embodiments, the measured sample is then pumped back to the wellhead via the slipstream.

The method used by the automated system 102 as described in FIG. 3 can be fully automated or partially automated. In some embodiments, steps 304-312 are all automated, thereby requiring little to no human intervention. This is particularly the case for one or more of the steps from the extraction of sample (step 304) to displaying the results (step 312) (apart from using a computing device to establish settings such as extraction times, display settings, etc). In other embodiments, the automated system 102 is partially automated, thereby allowing some human interaction. In some example embodiments, measuring the sample (step 310) and/or extracting a sample (step 304) are not automated and performed by an operator.

FIG. 4 is a block diagram of an automated system 102 for detecting a flow pattern of a tracer in a reservoir. In some embodiments, this automated system 102 can be used to execute the method as described in FIG. 3. The automated system 102 includes a slipstream device 402, one or more filters 404, a phase separation device 406, and a tracer measurement device 408.

The slipstream device 402 provides an interface between the automated system 102 and the wellhead or a production manifold. The slipstream device 402 is used to extract samples from the well for measurement as well as reintroduce measured samples back into the produced fluid from the well such as at the wellhead or production manifold.

The at least one filter 404 is used to remove solids and sediment from the extracted sample. In order for most measurement devices to accurately measure the concentration of tracers, all solids must be removed from the sample. Solids can form within the well from erosion of pipes and/or rocks and sediment from the reservoir.

Once the sample is filtered, the sample is automatically pumped to a phase separation device 406. The phase separation device is used to separate the sample into an aqueous phase consisting of a combination of water and a tracer. Most measurement devices require an aqueous solution to accurately detect the concentration of a tracer in the fluid.

Once the sample is filtered and separated, the aqueous phase sample is measured using a measuring device. Types of measurement devices that can be used include, but are not limited to laboratory spectroscopes, fiber optic fluoro-spectroscopes, Hall Effect sensors, fluorometers, Geiger counters, gas chromatography measurement devices, and post column reaction spectroscopes. In some embodiments, the tracer measurement device can detect fluorescent type tracers below 50 ppb. The type of measurement device used by the systems 102 depends on the type of tracer injected into the reservoir or aquifer.

FIG. 5 is a flow chart of a system 500 using an automated tracer sampling and measurement system 102 as shown and described with respect to FIG. 1. The system includes a wellhead 502 and an automated system 102. In this embodiment, the automated system 102 further includes a slipstream 506, a phase separation device 508, a solids removal device, and a measuring device. A computing device 522 is used to automate various processes in the automated system 102, such as establishing how often extraction occurs and/or programming the measurement device 512. The computing device 522 is communicates with the automated system 102 via a data communication network 106 (FIG. 1).

The slipstream device 506 is used to extract samples from the wellhead 502 for measurement as well as reintroduce measured samples back into the produced fluid at the wellhead 502. Alternatively, in other embodiments, the slipstream device is connected to a production manifold (not shown) and used to extract samples and reintroduce measured samples at the production manifold. Once the slipstream device 506 extracts a sample from the wellhead 502, a phase separation device 508 separates the sample into an output sample 514 and an unfiltered aqueous phase sample 516. In some embodiments, the output sample 514 includes oil, gas, water, and/or sediments. In some embodiments, the unfiltered aqueous phase sample 516 includes clean water, tracer, and/or formations and other solids. As noted above, the measurement device requires a pure aqueous phase sample to make a proper measurement of one or more tracers in the sample. An example of a phase separation device is described in more detail with respect to FIGS. 6-7.

Once the phases are separated, the output sample 514 is reintroduced into the produced fluid from the well via the slipstream 506 and wellhead 502 (or production manifold). In this embodiment, the unfiltered aqueous phase sample 516 passes through a solid removal device 510. In some embodiments, the sample passes through a solid removal device 510 before a phase separation device 508.

The solid removal device 510 removes formations and any other solids 518 from the slipstream sample. The sample is then passed to a measurement device 512 to test the existence and concentration of at least one tracer in the sample. The measurement device 512 displays results (step 520) to a computing device 522 via the data communication network 106 (FIG. 1). In some embodiments, once the measurement is taken, the sample is then reintroduced into the wellhead 502 (or production manifold) via the slipstream 506.

FIG. 6 is a flow chart of an example process by which an automated tracer sampling and measurement system 600 can obtain samples using a hydrocyclone phase separation device 606. In this example, the process begins by extracting a sample out of a wellhead 602 and using a pump 604 to drive the sample into a hydrocyclone phase separation device 606. In this embodiment, the pump 604 provides a pressure, preferably greater than about 40 psi, that is used by the hydrocyclone phase separation device 606. A hydrocyclone phase separation device 606 is a cylindrical device that separates liquids of different densities. In this example embodiment, the hydrocyclone phase separation device 606 separates the sample into an output sample 608 and an unfiltered measurement sample 610. In other example embodiments, other substances are separated. The output sample 608 is then reintroduced back to the wellhead 602. The unfiltered measurement sample 610 is then sent to a filter 612 to remove unwanted solids and/or contaminants. In this embodiment, the filter is located external to the hydrocyclone phase separation device 606. In other embodiments, the filter is located inside the hydrocyclone phase separation device 606. In other embodiments, filter 612 is positioned prior to the hydrocyclone 606 or the pump 604. The filter 612 then outputs a measurement sample 614 that is sent to the measurement device 616 that measures the concentration of tracers in the sample. The measurement sample 614 is then reintroduced to the wellhead 602.

FIG. 7 is a flow chart of an example process by which an automated tracer sampling and measurement system 700 can use a vertical column gravity segregation system to obtain tracer samples. The embodiment of FIG. 7 therefore represents an alternative to the system 600 of FIG. 6, discussed above.

In this embodiment, the method begins by extracting a sample out of a wellhead 702. The sample then travels through a piston accumulator and pump 704 allowing the pressure of the sample to be reduced and larger solids to drop out. The sample then travels to a vertical column separator 706, which includes a parallel plate coalescer. The vertical column separator 706 is used to perform the separation of the sample into an output sample 708 and an unfiltered measurement sample 710 while the parallel plate coalescer removes yet more solids from the sample. In one or more embodiments, the filter 712 is positioned prior to the vertical column separator 706 or piston accumulator and pump 704. The output sample 708 is then reintroduced to the wellhead 702. The unfiltered measurement sample 710 is then sent to a filter 712 to remove residual solids from the sample. The measurement sample 714 is then sent to a measurement device 716 that measures the concentration of tracers in the sample. The measurement sample 714 is then reintroduced to the wellhead 702.

FIG. 8 is a flow chart of two alternative tracer measurement devices 800 used by an automated tracer sampling and measurement system. FIG. 8 is divided into two main types of tracer measurement devices: a high performance liquid chromatography (HPLC) measurement device 800 and a fluorescence spectroscope 802 used by an embodiment. In this embodiment, the fluorescence spectroscope 802, which is represented by the components below the dashed line, accepts a sample mixture 804 and processes the sample 804 using a series of detection components 806. The detection components 806 are responsible for detecting and measuring the fluorescein tracer concentration in the sample 804. The results are recorded using a recording device 808 as a function of concentration over time. In addition to the fluorescence spectroscope 802, an HPLC measurement device 800 (including features depicted above the dashed line) uses a solvent 810, a solvent delivery system 812, packed columns 818, and an injector 816.

FIG. 9 is a chart 900 illustrating combinations of alternative embodiments for the automated tracer sampling and measurement system 102 (FIG. 1). The chart is divided into columns labeled tracer type 902, wellhead type 904, producing fluids 906, fluid extraction method 908, contaminants removed 910, allowable fluid phase 912, and measurement device type 914. The current system is illustrated by the dashed line whereas the disclosed embodiment is illustrated by the solid line. Physical requirements dictate various devices that can be used in various combinations. The current system, as illustrated by the dashed line, uses an FBA tracer; a vertical topside wellhead; oil, water, and gas as allowable producing fluids; a no-reintroduce fluid extraction method; no contaminants removed; water, oil, oil/water microemulsion, and gas as the allowable fluid phase; and the use of a laboratory fluoro-spectroscope as the tracer measurement device. As illustrated by the solid line, embodiments of the present disclosure include an FBA tracer; a vertical topside wellhead; oil, water, and gas as allowable producing fluids; a slipstream as the sample extraction and reintroduction method; solid contaminants removed; water as the only allowable fluid phase; and the use of a fluorometer or a fiber optic fluoro-spectroscope tracer measurement device. Other combinations can also be used. For example, an alternative embodiment can use a magnetic nanoparticle tracer in combination with a Hall Effect sensor measurement device. Another alternative embodiment uses a radioactive tracer in combination with a Geiger counter measurement device. Additionally, some measurement methods will require a clean, aqueous phase sample with no formation solids or oil-water emulsions. Other embodiments require control of salinity or pH levels. In other embodiments, other combinations of alternative embodiments of the system 102 are used.

Referring generally to FIGS. 1-9, it is noted that the various embodiments discussed herein are particularly adapted or adaptable to single phase (aqueous phase) measurement of tracers. However, and consistent with the present disclosure, the overall automated tracer sampling systems discussed herein can also be applied to measure an oil phase without substantial changes to the physical design or process flow. Accordingly, the present disclosure is not limited to such single phase measurement applications.

Still referring generally to the systems and methods of FIGS. 1-9, and referring to in particular computing system of FIG. 1, embodying the methods and systems of the present disclosure, it is noted that various computing systems can be used to implement the processes disclosed herein, including directing the collection and processing of sample tracer measurements. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, aspects of the methods described herein can be practiced within a general purpose computer or in any other circuits or systems.

Embodiments of the present disclosure can be implemented as a computer process (method), a computing system, or as an article of manufacture, such as a computer program product or computer readable media. The computer program product may be a computer storage media readable by a computer system and encoding a computer program of instructions for executing a computer process. Accordingly, embodiments of the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media. Further, the disclosed methods' stages may be modified in any manner, including by reordering stages and/or inserting or deleting stages, without departing from the overall concept of the present disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. An automated tracer sampling and measurement system comprising:
a flange wellhead slipstream device connected to a producing well; and
a housing for an inline system used for tracer sampling and measurement, wherein the housing is connected to the flange wellhead slipstream device;
the inline system further comprising:
a phase separation system;
a tracer measurement device configured for detecting a concentration of an at least one tracer produced from a reservoir; and
a fluid flow system comprising of at least one of pipes, pumps, and valves.

2. The automated tracer sampling and measurement system of claim 1, wherein the flange wellhead slipstream device is connected to the producing well at a wellhead or a production manifold.

3. The automated tracer sampling and measurement system of claim 1, wherein the tracer measurement device further comprises a fluorometer capable of detecting a fluorescence type tracer with a detection threshold below 50 ppb.

4. The automated tracer sampling and measurement system of claim 1, wherein the tracer measurement device is capable of displaying concentration results over a network.

5. The automated tracer sampling and measurement system of claim 1, wherein the tracer measurement device further comprises a fiber optic fluoro-spectroscope capable of detecting a fluorescence type tracer with a detection threshold below 50 ppb.

6. The automated tracer sampling and measurement system of claim 1, wherein the phase separation system is a vertical column gravity segregation system.

7. The automated tracer sampling and measurement system of claim 1, wherein the phase separation system is a hydrocyclone system.

8. The automated tracer sampling and measurement system of claim 1 further comprising a power source for powering components within the system.

9. A method for sampling and measuring tracers, the method comprising:
automatically extracting, from produced fluid of a reservoir, a sample set of fluid, having at least two phases and at least one tracer, using a slipstream device;
automatically separating the at least two phases into a first phase and a second phase using a phase separation system;
automatically reintroducing the second phase into the produced fluid of the reservoir using the slipstream device;
automatically measuring a concentration of the at least one tracer in the first phase using a tracer measurement device; and
automatically reintroducing the first phase into the produced fluid of the reservoir using the slipstream device.

10. The method of claim 9, wherein the at least two phases are selected from a group consisting of oil, water, gas, oil-water microemulsions, or any combination thereof.

11. The method of claim 9, wherein the at least one tracer is selected from a group consisting of a fluorinated benzoic acid tracer, a fluorescein dye tracer, a fluorinated benzoic acid and a fluorescein synthesized tracer, a fluorescing nanocrystal tracer, a radioactive tracer, a fluorescing nanoparticle tracer, or a LUX Assure Tracer™, or any combination thereof.

12. The method of claim 9, wherein the phase separation system is a vertical column gravity segregation system.

13. The method of claim 9, wherein the phase separation system is a hydrocyclone system.

14. The method of claim 9, further comprising detecting a concentration of less than 50 ppb of the at least one tracer.

15. The method of claim 9, further comprising removing at least one contaminant from the sample set of fluid using a filtration system.

16. The method of claim 15, wherein the at least one contaminant is selected from a group consisting of salts or solids.

17. An automated tracer sampling and measurement device comprising:
a flange wellhead slipstream device; and
a housing for an inline system used for tracer sampling and measurement, wherein the housing is connected to the flange wellhead slipstream device;
the inline system comprising a phase separation system connected to a tracer measurement device configured for detecting a concentration of at least one tracer, and a fluid transport system comprising of a series of piping and valves.

18. The automated tracer sampling and measurement device of claim 17, wherein the tracer measurement device is selected from a group consisting of a fluorometer, a Hall Effect sensor, a fiber optic fluorescence spectroscope, a secondary reaction fluorometer, a laboratory spectroscope, a Geiger counter, and a gas chromatography device.

19. The automated tracer sampling and measurement device of claim 17, wherein the tracer measurement device further has a low tracer detection threshold.

20. The automated tracer sampling and measurement device of claim 17, further comprising at least one pump for producing a pressure gradient.

21. The automated tracer sampling and measurement device of claim 17, further comprising an external power source capable of powering electrical components within the system.
